(19) United States
(12) Patent Application Publication
(10) Pub. No.: US 2026/0178537 A1
(43) Pub. Date: Jun. 25, 2026

(54) MEMORY MAPPING FOR MULTIPLE SYSTEM ON CHIP

(71) Applicant: Mercedes-Benz Group AG, Stuttgart (DE)

(72) Inventor: Francois Piednoel, Sunnyvale, CA (US)

(21) Appl. No.: 18/990,899

(22) Filed: Dec. 20, 2024

(51) Int. Cl. G06F 15/78; G06F 12/02

(52) U.S. Cl. CPC G06F 15/781; G06F 12/0246

(57) ABSTRACT

A memory mapping system includes chiplets that each include a local memory storage with a first predefined address range within a global memory space and a local network on chip with local network interface units to route memory access requests in the first predefined address range to the local memory storage. A control chiplet includes a global memory storage accessible to the other chiplets with a second predefined address range within the global memory space. The control chiplet includes a network on chip with network interface units to route memory access requests in the second predefined address range to the global memory storage. The control chiplet also includes a mailbox system connected to the network on chip. The mailbox system includes a reservation table to track memory access requests made to the global memory storage and a mechanism that prevents simultaneous requests to memory addresses within the global memory storage.

### BACKGROUND

A system-on-chip (SoC) can comprise an integrated circuit that combines multiple components of a computer or electronic system onto a single chip, providing a compact and efficient solution for a wide range of applications. The main advantage of an SoC is its compactness and reduced complexity, since all the components are integrated onto a single chip. This reduces the need for additional circuit boards and other components, which can save space, reduce power consumption, and reduce overall cost. The components of an SoC are often referred to as chiplets, which are small, self-contained semiconductor components that can be combined with other chiplets to form the SoC.

Chiplets are designed to be highly modular and scalable, allowing for the creation of complex systems from smaller, simpler components and are typically designed to perform specific functions or tasks, such as memory, graphics processing, or input/output (I/O) functions. They may be interconnected with each other and with a main processor or controller using high-speed interfaces. Chiplets offer increased modularity, scalability, and manufacturing efficiency compared to traditional and current monolithic chip designs, as well as the ability to be tested individually before being combined into the larger system.

### BRIEF DESCRIPTION OF THE DRAWINGS

FIG. 1 illustrates a memory mapping system for a multiple system on chip, in accordance with examples described herein.

FIG. 2 is a block diagram illustrating an example central chiplet of an SoC arrangement for executing workloads, in accordance with examples described herein.

FIG. 3 is a block diagram illustrating memory mapping between a chiplet memory space and a central chiplet memory space, in accordance with examples described herein.

FIG. 4 is a flow chart describing an example method of controlling memory accesses within a memory mapping system for a multiple system on chip.

### DETAILED DESCRIPTION

Examples provide for a memory mapping scheme for a system of chiplets designed for autonomous vehicles. The system provides a structured, efficient memory access pattern between chiplets and a central mailbox chiplet. This approach aims to reduce power consumption, minimize latency, and maintain a stable order of memory transactions. Features include local memory allocation for each chiplet, access control via address ranges, and a unique mailbox system to manage data dependencies and prevent memory conflicts.

An example system departs from conventional approaches that utilize industry standards like PCI and CXL, which require complex two-way communications and consume significant power for continuous data validation. Here, a simple address-based protocol without additional interconnect protocols efficiently partitions local and global memory, supporting one-directional communication.

Advantages of the memory mapping scheme include local memory allocation, meaning each chiplet has access to a designated local memory space, reducing the need for global memory transactions and improving processing efficiency. In addition, the memory mapping scheme supports single-directional communication. That is, all memory access requests originate from the chiplets to the central mailbox, eliminating the need for complex protocols (e.g., PCI, CXL) and ensuring simplified communication. Furthermore, the mailbox and reservation table prevent write conflicts while significantly reducing power consumption and latency. For example, the system can reduce power consumption by approximately 30-40% compared to traditional systems, where atomic operations require continuous polling for potential read/write conflicts. By managing memory through buffer-based semaphore control, the mailbox and reservation table avoid unnecessary memory traffic and allow only data flow in the direction of the central control chiplet.

Each chiplet is equipped with its own local memory, and access to it is determined by address ranges. Access requests within a defined range (e.g., 0-8GB) are routed to the chiplet's local memory, including HBM (High-Bandwidth Memory) or SRAM, depending on memory configuration. Access requests beyond the chiplet's range and above 64GB target the control chiplet's memory, which also holds HBM and caches shared resources among chiplets.

Each chiplet has private memory within 0-16GB. Global memory allocations and shared memory zones start at 64GB and go beyond, segmented by each connected device (e.g., MSoC0, MSoC1). Above 768GB, requests access flash memory, designated as a final storage area for non-volatile data. This structure allows chiplets to access both local and shared memory without conflicting with other chiplets'address spaces.

Requests from chiplets are directed towards the central chiplet, which manages central memory storage. In some aspects, the central chiplet does not query chiplet memory directly, simplifying memory communication. In further aspects, the central chiplet may access chiplet memory. Chiplet addresses for HBM are isolated from shared memory addresses, avoiding cross-chiplet interference. This segregation ensures that each chiplet accesses only its intended memory space or shared memory in the control chiplet without risking data corruption.

The memory mapping system also differentiates memory spaces between system-on-chips (SOCs), such as MSoC0 and MSoC1, facilitating controlled access without additional protocols. The mailbox within the central chiplet acts as a semaphore, controlling access requests. It ensures that no chiplet reads or writes in a memory segment that another chiplet or the central chiplet is using, preventing simultaneous access. A reservation table within the mailbox maintains a record of current memory operations, marking memory as reserved when in use. For example, if a chiplet writes to the control chiplet's memory, the reservation table blocks other chiplets from accessing the same address range until the operation completes. By using the mailbox system, the invention bypasses atomic memory currency, saving power and avoiding the need for system-wide memory checks on every access.

In the context of autonomous vehicles, the compute chiplets handle local computations for data from sensors (e.g., cameras, radar, LIDAR), using local memory for intermediary calculations and global memory in the central chiplet for shared results. Machine learning models can perform computations in local chiplet memory, storing only necessary results in global memory to be accessed by other chiplets. By isolating specific memory zones for different chiplets, the system supports high-throughput, low-latency processing required for real-time autonomous decisions.

In some aspects, a memory mapping system includes chiplets that each include a local memory storage with a first predefined address range within a global memory space and a local network on chip with local network interface units to route memory access requests in the first predefined address range to the local memory storage. A control chiplet includes a global memory storage accessible to the other chiplets with a second predefined address range within the global memory space. The control chiplet includes a control network on chip with control network interface units to route memory access requests in the second predefined address range to the global memory storage. The control chiplet also includes a mailbox system connected to the control network on chip. The mailbox system includes a reservation table to track the memory access requests made to the global memory storage and a semaphore mechanism that prevents simultaneous requests from different chiplets to memory addresses within the global memory storage.

In some aspects, the chiplet network interface units route memory access requests outside the predefined address range to the first control chiplet.

In some aspects, a second control chiplet coupled to the first control chiplet includes a secondary global memory storage. Upon determining that a given memory access request is within a third predefined address range, the control network interface units translate the given memory access request to a secondary global memory storage range and forward the given memory access request to the second control chiplet.

In some aspects, the mailbox system includes logic to manage the order of memory access operations such that a write operation must complete before subsequent read or write operations to the same address range are permitted.

In some aspects, the mailbox system programs the plurality of control network interface units to enforce traffic routing rules.

In some aspects, the memory mapping system facilitates unidirectional communication, such that all memory access requests are initiated by the plurality of chiplets to the global memory storage, and the first control chiplet does not issue memory access requests to the plurality of chiplets.

In some aspects, the mailbox system is configured to minimize power consumption by avoiding atomic-level memory currency operations and instead using buffer-level access management.

One or more aspects described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more aspects described herein can be implemented using programmatic modules, engines, or components. A programmatic module, engine, or component can include a program, a sub-routine, a portion of a program, a software component, or a hardware component capable of performing one or more stated tasks or functions. As used herein, a module or component can exist on a hardware component independently of other modules or components. Alternatively, a module or component can be a shared element or process of other modules, programs, or machines.

Furthermore, one or more aspects described herein may be implemented through the use of instructions that are executable by one or more processors. These instructions may be stored on a computer-readable medium. Machines shown or described with figures below provide examples of processing resources and computer-readable media on which instructions for implementing some aspects can be stored and/or executed. In particular, the numerous machines shown or described include processors and various forms of memory for storing data and instructions. Examples of computer-readable media include permanent memory storage devices, such as hard disk drives on personal computers or servers. Other examples of computer storage media include portable storage units, such as CD or DVD units, flash or solid-state memory (such as carried on cell phones, tablets, and other consumer electronic devices), and magnetic memory. Computers, terminals, and network-enabled devices (e.g., mobile devices such as cell phones) are all examples of machines and devices that utilize processors, memory, and instructions stored on computer-readable media.

Alternatively, one or more examples described herein may be implemented through the use of dedicated hardware logic circuits that are comprised of an interconnection of logic gates. Such circuits are typically designed using a hardware description language (HDL), such as Verilog and VHDL. These languages contain instructions that ultimately define the layout of the circuit. However, once the circuit is fabricated, there are no instructions, and processing is performed by interconnected gates.

### SYSTEM OVERVIEW

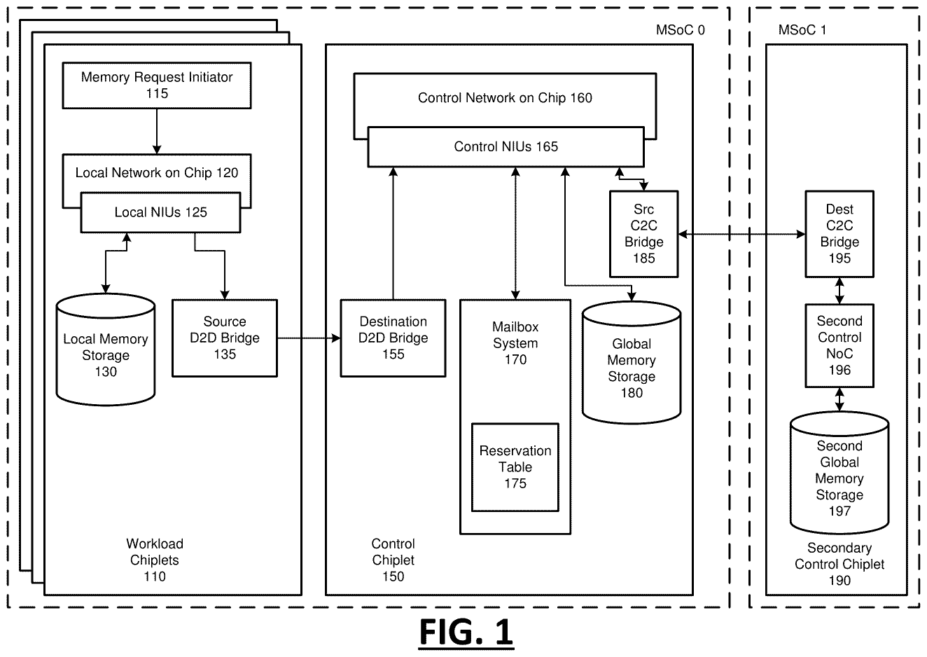

FIG. 1 illustrates a memory mapping system for a multiple system on chip, in accordance with examples described herein. The multiple system on chip comprises two systems on chip, MSoC0 and MSoC1. In various examples, MSoC0 can include a number of workload chiplets 110 and a control chiplet 150 with a first global memory storage 180. MSoC1 can include its own workload chiplets (not illustrated) and a secondary control chiplet 190 with a second global memory storage 197. MSoC0 and MSoC1 are connected by an interconnect (i.e., source C2C bridge 185 and destination C2C bridge 195) that enables the SoCs to read and write from each other's memory storage. During any given session, MSoC0 and MSoC1 may alternate roles between a primary SoC and a backup SoC. In one example of an autonomous vehicle, the primary SoC can perform various autonomous driving tasks, such as perception, object detection and classification, grid occupancy determination, sensor data fusion and processing, motion prediction (e.g., of dynamic external entities), motion planning, and vehicle control tasks. The backup SoC can maintain a set of computational components (e.g., CPUs, ML accelerators, and/or memory chiplets) in a low power state, and continuously or periodically read the memory of the primary SoC.

In some aspects, at system startup, local network interface units (NIUs) 125 on the workload chiplets 110 and control NIUs 165 on the control chiplet 150 are programmed with routing tables that determine which memory addresses belong to the local chiplet (i.e., a first predefined memory range), the control chiplet 150 global memory storage 180 (i.e., a second predefined memory range), and the second global memory storage 197 on the secondary control chiplet 190 (i.e., a third predefined memory range). In one example, the predefined memory ranges reflect a situation where each of the system components is functioning within operating parameters. However, on boot, if the MSoC detects that one or more system components is malfunctioning, the NIUs can be programmed with routing tables according to one or more predetermined degradation schemes. For example, if the MSoC1 experiences hardware failure, the second global memory storage 197 may be inaccessible, and accordingly, the NIUs on MSoC0 are programmed to not forward memory access requests to the third predefined memory range.

When a memory request initiator 115 (e.g., a processor) for one of the workload chiplets 110 in the MSoC0 requests to read or write an amount of data starting at a specific memory address, a local network on chip (NoC) 120 on that workload chiplet 110 receives the memory access request for processing.

Local NIUs 125 route the memory access request based on the memory address specified in the request. Any memory access request within the first predefined memory range is considered a local memory address to be handled by chiplet local memory storage 130. For example, a memory controller on the local chiplet may write or read the requested data from RAM on the workload chiplet 110 or from an attached high-bandwidth memory if present.

Requests for memory outside the first predefined memory range can be translated to the global memory space using address translators present in the high bandwidth NoC initiator NIUs. These programmable translators can map any chiplets with any address range to any range in the global memory space. In some aspects, translation regions are defined by incoming base address, outgoing base address, and buffer size.

For memory access requests outside of the local memory address range, the local NIUs 125 send the request to a source die-to-die (D2D) bridge 135, which transmits the request to a destination D2D bridge 155 on the control chiplet 150. In some aspects, the NIUs 125 and D2D bridges 135, 155 facilitates unidirectional communication, such that all memory access requests are initiated by the workload chiplets 110 to the global memory storage 180, and the control chiplet 150 does not issue memory access requests to the workload chiplets 110.

On the control chiplet 150, control NIUs 165 on a control NoC 160 determine whether the memory access request is for the control chiplet 150 or the secondary control chiplet 190. A reservation table 175 within the mailbox system 170 of the global memory operates a semaphore mechanism that prevents simultaneous requests from different workload chiplets 110 to memory addresses within the global memory storage 180. Accordingly, if the semaphore mechanism has locked the memory address range associated with an access request, the control NIUs 165 will deny the request. Otherwise, if the memory address range is not locked, the control NIUs 165 forward the request to a memory controller on the control chiplet 150. The memory controller on the control chiplet may write or read the requested data from RAM on the chiplet or from an attached high-bandwidth memory.

In some aspects, when one of the workload chiplets 110 begins processing data associated with a workload managed by the mailbox system 170, the mailbox system 170 checks the reservation table 175 for the memory address ranges associated with that workload's data stored in the global memory storage 180. The mailbox system 170 may then activate the semaphore mechanism and mark that workload in the reservation table 175 as locked. The reservation table 175 thereby keeps track of which of the workload chiplets 110 are accessing which areas of the global memory storage 180. In addition, the mailbox system 170 may reprogram the control NIUs 165 to update their routing tables, enforcing traffic routing rules, to prevent different workload chiplets 110 from reading or writing to that memory address range. Accordingly, the mailbox system 170 ensures that any write operation must complete before subsequent read or write operations to the same address range are permitted. Furthermore, the mailbox system 170 buffer-level access management minimizes power consumption by avoiding atomic-level memory concurrency operations.

Any memory access request to addresses on the control chiplet 150 (i.e., within the second predefined address range) are handled by the global memory storage 180 on the control chiplet 150. If the memory access request is for a range associated with the secondary control chiplet 190 (i.e., within the third predefined address range), the control NIUs 165 perform buffer address translation and transmit the memory access request to the source chip-to-chip bridge 185. The memory access request is then sent across the bridge to the destination chip-to-chip bridge 195 where it is handled by a second control NoC 196. The memory controller on the secondary control chiplet 190 may write or read the requested data from RAM on the chiplet or from an attached high-bandwidth memory.

### EXAMPLE CONTROL CHIPLET

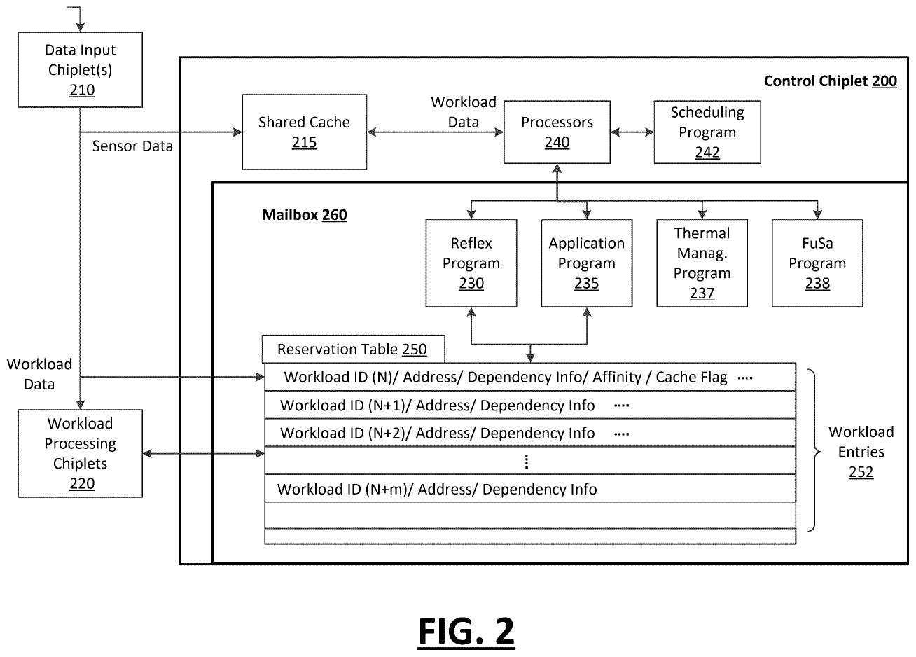

FIG. 2 is a block diagram illustrating an example control chiplet of an SoC arrangement for executing workloads, in accordance with examples described herein. The control chiplet 200 shown in FIG. 2 can correspond to the control chiplet 150 of the MSoC0 as shown in FIG. 1. Furthermore, the data input chiplet 210 and workload processing chiplets 220 of FIG. 2 can correspond to workload chiplets 110 shown in FIG. 1.

Referring to FIG. 2, the control chiplet 200 can include a mailbox 260 storing a reflex program 230 and an application program 235. As provided herein, the reflex program 230 can comprise a set of instructions for executing reflex workloads. The reflex workloads can comprise sensor data acquisition, sensor fusion, and inference tasks that facilitate scene understanding of the surrounding environment of the vehicle. These tasks can comprise two-dimensional image processing, sensor fused data processing (e.g., three-dimensional LIDAR, radar, and image fusion data), neural radiance field (NeRF) scene reconstruction, occupancy grid determination, object detection and classification, motion prediction, and other scene understanding tasks for autonomous vehicle operation.

As further provided herein, the application program 235 can comprise a set of workload instructions for operating the vehicle controls of an autonomous vehicle based on the output of the reflex workloads. For example, the application program 235 can be executed by one or more processors 240 of the control chiplet 200 and/or one or more of the workload processing chiplets 220 (e.g., the autonomous drive chiplet 240 of FIG. 2) to dynamically generate a motion plan for the vehicle based on the execution of the reflex workloads, and operate the vehicle's controls (e.g., acceleration, braking, steering, and signaling systems) to execute the motion plan accordingly.

In various implementations, the control chiplet 200 can include a set of one or more processors 240 (e.g., a transient-resistant CPU and general compute CPUs) that can execute a scheduling program 242 for execution of workloads as runnables in independent pipelines (e.g., in accordance with the compute task and data positioning optimizations described herein). In certain examples, one or more of the processors 240 can execute reflex workloads in accordance with the reflex program 230 and/or application workloads in accordance with the application program 235. As such, the processors 240 of the control chiplet 200 can reference, monitor, and update dependency information in workload entries of the reservation table 250 as workloads become available and are executed accordingly. For example, when a workload is executed by a particular chiplet, the chiplet updates the dependency information of other workloads in the reservation table 250 to indicate that the workload has been completed. This can include changing a binary value representing the workload (e.g., from 0 to 1) to indicate in the reservation table 250 that the workload has been completed. Accordingly, the dependency information for all workloads having dependency on the completed workload is updated accordingly.

According to examples described herein, the reservation table 250 can include workload entries, each of which indicates a workload identifier that describes the workload to be performed, an address in the cache memory 215 and/or HBM-RAM of the location of raw or processed sensor data required for executing the workload, any dependency information corresponding to dependencies that need to be resolved prior to executing the workload, and/or affinity information specifying which hardware component is to execute the runnable when the workload is available (e.g., when all dependencies are met). In certain aspects, the dependencies can correspond to other workloads that need to be executed. Once the dependencies for a particular workload are resolved, the workload entry can be updated (e.g., by the chiplet executing the dependent workloads, or by the processors 240 of the control chiplet 200 through execution of the scheduling program 242). When no dependencies exist for a particular workload as referenced in the reservation table 250, the workload can be executed in a respective pipeline by a corresponding workload processing chiplet 220.

In various implementations, the sensor data input chiplet 210 obtains sensor data from the sensor system of the vehicle, and stores the sensor data (e.g., image data, LIDAR data, radar data, ultrasonic data, etc.) in a cache 215 of the control chiplet 200. The sensor data input chiplet 210 can generate workload entries for the reservation table 250 comprising identifiers for the sensor data (e.g., an identifier for each obtained image from various cameras of the vehicle's sensor system) and provide an address of the sensor data in the cache memory 215. An initial set of workloads be executed on the raw sensor data by the processors 240 of the control chiplet 200 and/or workload processing chiplets 220, which can update the reservation table 250 to indicate that the initial set of workloads have been completed.

As described herein, the workload processing chiplets 220 monitor the reservation table 250 to determine whether particular workloads in their respective pipelines are ready for execution. As an example, the workload processing chiplets 220 can continuously monitor the reservation table using a workload window (e.g., an instruction window for multimedia data) in which a pointer can sequentially read through each workload entry to determine whether the workloads have any unresolved dependencies. If one or more dependencies still exist in the workload entry, the pointer progresses to the next entry without the workload being executed. However, if the workload indicates that all dependencies have been resolved (e.g., all workloads upon which the particular workload depends have been executed), then the relevant workload processing chiplet 220 and/or processors 240 of the control chiplet 200 can execute the workload accordingly.

In various examples, the mailbox 260 can include a thermal management program 237 executable by the one or more processors 240 to manage the various temperatures of the SoC, operate cooling components, perform hardware throttling, switch to backup components (e.g., a backup SoC), and the like. In still further examples, the mailbox 260 can include a FuSa program 238 that performs functional safety tasks for the control chiplet 200, such as monitoring communications within the SoC (e.g., using error correction code), comparing output of different pipelines, and monitoring hardware performance of the SoC.

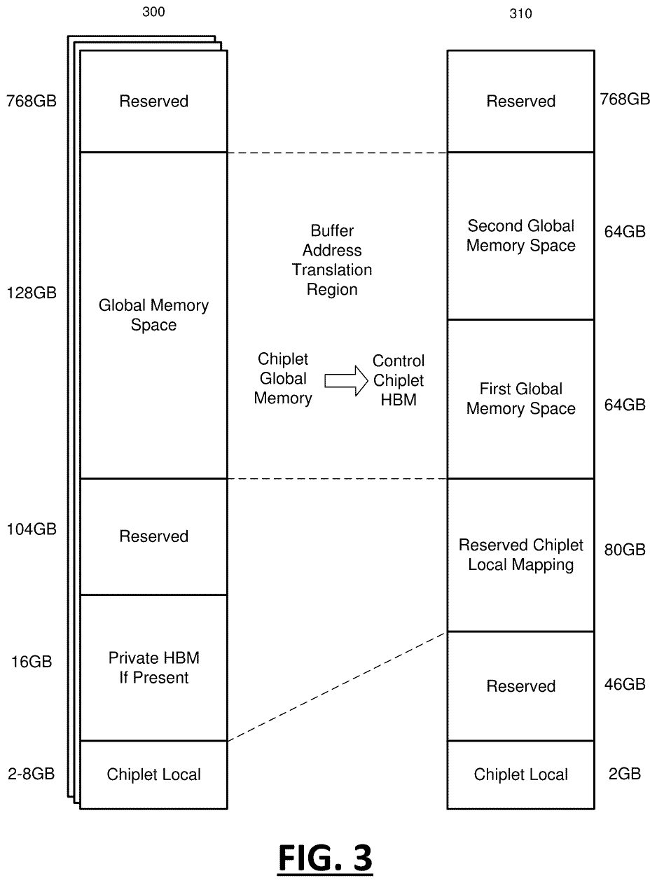

FIG. 3 is a block diagram illustrating memory mapping between a chiplet memory space and a central chiplet memory space, in accordance with examples described herein. Specific memory address ranges and amounts of memory assigned to each section of memory are used only as an example for ease of understanding; other examples exist of this memory addressing system using different memory address ranges. For example, a system with more available memory may address in terabytes instead of gigabytes.

In some aspects, two separate control chiplets are connected by chip-to-chip interconnects to form one single memory map 310. Each of the workload chiplets memory spaces 300 include private memory of 2-8GB for chiplet local memory plus an additional 16GB for a private HBM if present. Global memory allocations and shared memory zones start at 128GB and go beyond, segmented by each connected device (e.g., MSoC0, MSoC1). Above 768GB, requests access flash memory, designated as a final storage area for non-volatile data. This structure allows chiplets to access both local and shared memory without conflicting with other chiplets'address spaces. The ordering of memory address ranges is provided as an example only. Other aspects of this memory mapping scheme may rearrange the starting and ending memory addresses of each section and the ordering of individual memory spaces within the memory map.

For memory writes in the 128GB global memory space, network interface units in the system perform buffer address translation. In the first 64GB of the global memory space, memory access requests go to the first control chiplet on MSoC0. In the second 64GB of the global memory space, memory access requests go to the second control chiplet on MSoC1.

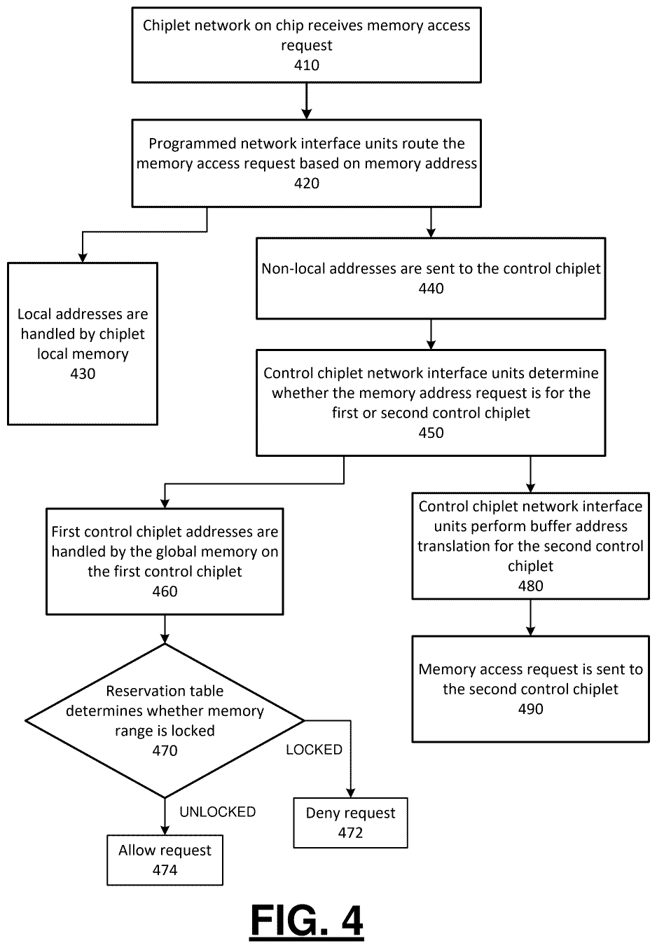

FIG. 4 is a flow chart describing an example method of controlling memory accesses within a memory mapping system for a multiple system on chip.

First, processors for one of the workload chiplets in the MSoC request to read or write an amount of data starting at a specific memory address. A network on chip on that workload chiplet receives the memory access request for processing (410).

The network interface units route the memory access request based on the memory address specified in the request (420). Any memory access request to a local memory address (e.g., within the first 128GB of addressable space) are handled by chiplet local memory (430). For example, a memory controller on the local chiplet may write or read the requested data from RAM on the chiplet or from an attached high-bandwidth memory if present.

For memory access requests outside of the local memory address range, the network interface units send the request across a die-to-die bridge to the first control chiplet (440). On the first control chiplet, network interface units determine whether the memory access request is for the first or second control chiplet (450).

Any memory access request to addresses on the first control chiplet are handled by the global memory on the first control chiplet (460). A reservation table within the mailbox system of the global memory operates a semaphore mechanism that prevents simultaneous requests from different chiplets to memory addresses within the global memory storage (470). Accordingly, if the semaphore mechanism has locked the memory address range associated with the access request, the network interface units will deny the request (472). Otherwise, if the memory address range is not locked, the network interface units forward the request to a memory controller on the control chiplet. The memory controller on the control chiplet may write or read the requested data from RAM on the chiplet or from an attached high-bandwidth memory.

If the memory access request is for a range associated with the second control chiplet, network interface units on the first control chiplet perform buffer address translation and transmit the memory access request to a chip-to-chip bridge (480). The memory access request is then sent across the bridge to the second control chiplet (490). The memory controller on the second control chiplet may write or read the requested data from RAM on the chiplet or from an attached high-bandwidth memory.

Examples described herein are related to the use of a computer system for implementing the techniques described. According to one aspect, those techniques are performed by a computer system in response to a processor executing one or more sequences of one or more instructions contained in main memory. Such instructions may be read into main memory from another machine-readable medium, such as a storage device. Execution of the sequences of instructions contained in main memory causes the processor to perform the process steps described herein. In alternative aspects, hard-wired circuitry may be used in place of or in combination with software instructions to implement aspects described herein. Thus, aspects described are not limited to any specific combination of hardware circuitry and software.

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature. Thus, the absence of describing combinations should not preclude having rights to such combinations.

What is claimed is:

1. A memory mapping system for a chiplet-based computing architecture, comprising:
a plurality of chiplets, each comprising:
a local memory storage with a first predefined address range within a global memory space; and
a local network on chip with a plurality of local network interface units configured to route memory access requests in the first predefined address range to the local memory storage; and
a first control chiplet comprising:
a global memory storage accessible to the plurality of chiplets with a second predefined address range within the global memory space;
a control network on chip with a plurality of control network interface units configured to route memory access requests in the second predefined address range to the global memory storage; and
a mailbox system connected to the control network on chip, the mailbox system comprising:
a reservation table configured to track the memory access requests made to the global memory storage; and
a semaphore mechanism that prevents simultaneous requests from different chiplets of the plurality of chiplets to memory addresses within the global memory storage.

2. The system of claim 1, wherein the plurality of chiplet network interface units route memory access requests outside the predefined address range to the first control chiplet.

3. The system of claim 1, further comprising:
a second control chiplet coupled to the first control chiplet, the second control chiplet comprising:
a secondary global memory storage, wherein upon determining that a given memory access request is within a third predefined address range, the plurality of control network interface units translate the given memory access request to a secondary global memory storage range and forward the given memory access request to the second control chiplet.

4. The system of claim 1, wherein the mailbox system further includes logic to manage the order of memory access operations such that a write operation must complete before subsequent read or write operations to the same address range are permitted.

5. The system of claim 1, wherein the mailbox system programs the plurality of control network interface units to enforce traffic routing rules.

6. The system of claim 1, wherein the memory mapping system facilitates unidirectional communication, such that all memory access requests are initiated by the plurality of chiplets to the global memory storage, and the first control chiplet does not issue memory access requests to the plurality of chiplets.

7. The system of claim 1, wherein the mailbox system is configured to minimize power consumption by avoiding atomic-level memory concurrency operations and instead using buffer-level access management.

8. A system on chip comprising:
a plurality of chiplets, each comprising:
a local memory storage with a first predefined address range within a global memory space; and
a local network on chip with a plurality of local network interface units configured to route memory access requests in the first predefined address range to the local memory storage; and
a first control chiplet comprising:
a global memory storage accessible to the plurality of chiplets with a second predefined address range within the global memory space;
a control network on chip with a plurality of control network interface units configured to route memory access requests in the second predefined address range to the global memory storage; and
a mailbox system connected to the control network on chip, the mailbox system comprising:
a reservation table configured to track the memory access requests made to the global memory storage; and
a semaphore mechanism that prevents simultaneous requests from different chiplets of the plurality of chiplets to memory addresses within the global memory storage.

9. The system on chip of claim 8, wherein the plurality of chiplet network interface units route memory access requests outside the predefined address range to the first control chiplet.

10. The system on chip of claim 8, further comprising:
a second control chiplet coupled to the first control chiplet, the second control chiplet comprising:
a secondary global memory storage, wherein upon determining that a given memory access request is within a third predefined address range, the plurality of control network interface units translate the given memory access request to a secondary global memory storage range and forward the given memory access request to the second control chiplet.

11. The system on chip of claim 8, wherein the mailbox system further includes logic to manage the order of memory access operations such that a write operation must complete before subsequent read or write operations to the same address range are permitted.

12. The system on chip of claim 8, wherein the mailbox system programs the plurality of control network interface units to enforce traffic routing rules.

13. The system on chip of claim 8, wherein the memory mapping system facilitates unidirectional communication, such that all memory access requests are initiated by the plurality of chiplets to the global memory storage, and the first control chiplet does not issue memory access requests to the plurality of chiplets.

14. The system on chip of claim 8, wherein the mailbox system is configured to minimize power consumption by avoiding atomic-level memory concurrency operations and instead using buffer-level access management.

15. A multiple system on chip (MSoC), comprising:
a plurality of chiplets, each comprising:
a local memory storage with a first predefined address range within a global memory space; and
a local network on chip with a plurality of local network interface units configured to route memory access requests in the first predefined address range to the local memory storage; and
a first control chiplet comprising:
a global memory storage accessible to the plurality of chiplets with a second predefined address range within the global memory space;
a control network on chip with a plurality of control network interface units configured to route memory access requests in the second predefined address range to the global memory storage; and
a mailbox system connected to the control network on chip, the mailbox system comprising:
a reservation table configured to track the memory access requests made to the global memory storage; and
a semaphore mechanism that prevents simultaneous requests from different chiplets of the plurality of chiplets to memory addresses within the global memory storage.

16. The multiple system on chip of claim 15, wherein the plurality of chiplet network interface units route memory access requests outside the predefined address range to the first control chiplet.

17. The multiple system on chip of claim 15, further comprising:
a second control chiplet coupled to the first control chiplet, the second control chiplet comprising:
a secondary global memory storage, wherein upon determining that a given memory access request is within a third predefined address range, the plurality of control network interface units translate the given memory access request to a secondary global memory storage range and forward the given memory access request to the second control chiplet.

18. The multiple system on chip of claim 15, wherein the mailbox system further includes logic to manage the order of memory access operations such that a write operation must complete before subsequent read or write operations to the same address range are permitted.

19. The multiple system on chip of claim 15, wherein the mailbox system programs the plurality of control network interface units to enforce traffic routing rules.

20. The multiple system on chip of claim 15, wherein the memory mapping system facilitates unidirectional communication, such that all memory access requests are initiated by the plurality of chiplets to the global memory storage, and the first control chiplet does not issue memory access requests to the plurality of chiplets.
